(19) United States
(12) Patent Application Publication
(10) Pub. No.: US 2022/0392008 A1
(43) Pub. Date: Dec. 8, 2022

(54) DEVICE, SYSTEM AND METHOD FOR POSITIONING MONITORS IN SCHOOLS

(71) Applicant: MOTOROLA SOLUTIONS, INC., Chicago, IL (US)

(72) Inventors: Pawel JURZAK, Krakow (PL); Yanyan HU, Medford, MA (US); Daniel R. BESTOR, Schaumburg, IL (US)

(21) Appl. No.: 17/763,126

(22) PCT Filed: Nov. 6, 2019
(86) PCT No.: PCT/PL2019/050062

§ 371 Date: Mar. 23, 2022

(51) Int. Cl. G06Q 50/26; G06Q 50/20; G06Q 50/00; G06Q 10/06; H04W 4/12; G06V 20/52

(52) U.S. Cl. CPC G06Q 50/265; G06Q 50/205; G06Q 50/01; G06Q 10/063112; H04W 4/12; G06V 20/52

(57) ABSTRACT

A device, system and method for positioning monitors in schools is provided. One or more memories store: adversarial relationship data identifying adversarial relationships between students at a school; and schedule data indicative of spatiotemporal locations of the students having the adversarial relationships. A device accesses the adversarial relationship data and the schedule data. The device determines, based on the schedule data, spatiotemporal crosspaths at the school of the students having the adversarial relationships. The device determines a ranking of the spatiotemporal crosspaths. The device assigns one or more monitors to one or more of the spatiotemporal crosspaths. The device transmits notifications to communication devices associated with the one or more monitors, the notifications to instruct the one or more monitors to move to a respective assigned spatiotemporal crosspath.

### BACKGROUND OF THE INVENTION

In schools, a safety and security challenge is to ensure that students with adversarial relationships do not get into adversarial incidents, such as fights and the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for positioning monitors in schools, in accordance with some examples.

FIG. 2 is a device diagram showing a device structure of a device for positioning monitors in schools, in accordance with some examples.

FIG. 3 is a flowchart of a method for positioning monitors in schools, in accordance with some examples.

FIG. 4 depicts a map showing ranked spatiotemporal crosspaths and monitor locations, in accordance with some examples.

FIG. 5 depicts the system of FIG. 1 transmitting notifications to communication devices associated with the monitors, to instruct the monitors to move to a respective assigned spatiotemporal crosspath, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In schools, a safety and security challenge is to ensure that students with adversarial relationships do not get into adversarial incidents, such as fights, bullying, arguments and the like. Such adversarial relationships may be determined from school records, analysis of video, and the like. Furthermore, schedule data of the students may be used to determine where and when students with adversarial relationships are most likely to cross paths, for example during a school day, by determining previous and next classroom locations of the students and a path therebetween. However, previous and next locations of the students may not be classrooms, but any suitable location associated with a school; for example, the schedule data may be a class schedule of the students and/or include locations of the students at particular times during school hours (e.g., determined via video surveillance of the school, and the like). Monitors, such as teachers, may be assigned to move to the locations, and times, where the students with adversarial relationships are most likely to cross paths to prevent the students from fighting, and the like. A combination of a crosspath location and time is referred to herein as a spatiotemporal crosspath, as a crosspath location may be associated with both an estimated location and estimated time that the students may cross paths. Indeed, a given spatiotemporal crosspath may identify a respective location and a respective time at the school where two or more of the students having an adversarial relationship are predicted and/or estimated to cross paths. For example, students may cross paths during passing periods; for example, a passing period may be a time period that students change classes and/or locations, and a non-passing period may be a time period in which students (e.g., and teachers) are in class.

An aspect of the present specification provides a method comprising: accessing, at a computing device, adversarial relationship data identifying adversarial relationships between students at a school; accessing, at the computing device, schedule data indicative of spatiotemporal locations of the students having the adversarial relationships; determining, at the computing device, based on the schedule data, spatiotemporal crosspaths at the school of the students having the adversarial relationships; determining, at the computing device, a ranking of the spatiotemporal crosspaths; assigning, based on the ranking, one or more monitors to one or more of the spatiotemporal crosspaths; and transmitting, at the computing device, notifications to communication devices associated with the one or more monitors, the notifications to instruct the one or more monitors to move to a respective assigned spatiotemporal crosspath.

Another aspect of the present specification provides a device comprising: a communication unit; and a controller in communication with the communication unit and having access to one or more memories storing: adversarial relationship data identifying adversarial relationships between students at a school; and schedule data indicative of spatiotemporal locations of the students having the adversarial relationships, the controller configured to: access the adversarial relationship data and the schedule data; determine, based on the schedule data, spatiotemporal crosspaths at the school of the students having the adversarial relationships; determine a ranking of the spatiotemporal crosspaths; assign one or more monitors to one or more of the spatiotemporal crosspaths; and transmit, via the communication unit, notifications to communication devices associated with the one or more monitors, the notifications to instruct the one or more monitors to move to a respective assigned spatiotemporal crosspath.

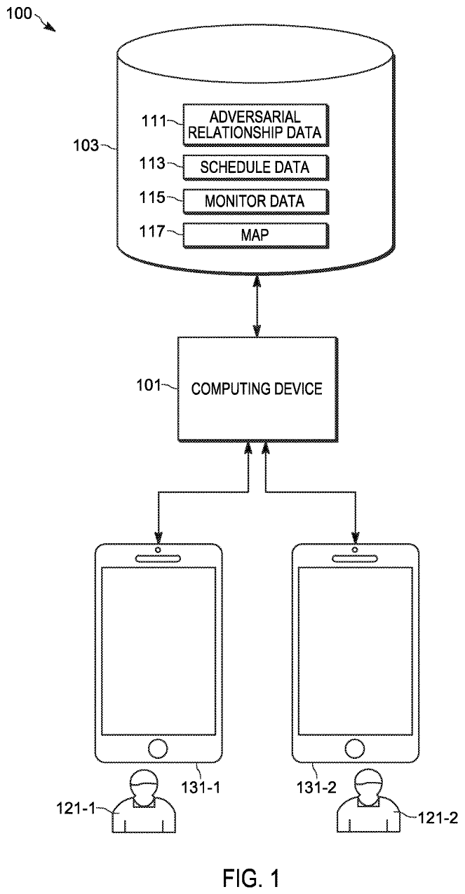

Attention is directed to FIG. 1, which depicts an example system 100 for positioning monitors in schools. Communication links between components of the system 100 are depicted in FIG. 1, and throughout the present specification, as double-ended arrows between respective components; the communication links may include any suitable combination of wireless and/or wired links and/or wireless and/or wired communication networks. The system 100 comprises a computing device 101 (interchangeably referred to hereafter as the device 101) that has access to one or more memories which, as depicted, may be in the form of a database 103. As depicted, the database 103 stores adversarial relationship data 111, identifying adversarial relationships between students at a school, and schedule data 113, indicative of spatiotemporal locations of the students having the adversarial relationships. For example, the computing device 101 and the database 103 may be operated on-premises by a school or may be operated in a cloud cluster by a third party as a service provided to and accessible to the school via network connection such as via the Internet, and each of the adversarial relationship data 111 and the schedule data 113 may be associated with students at the school.

As depicted, the database 103 further stores monitor data 115 indicating schedules, locations, and types of monitors associated with the school (e.g., teacher, other school staff such as an administrator and/or principal and/or a vice-principal, a nurse and/or guidance counselor, a volunteer, a hall monitor, a security guard and/or anyone else who may perform a monitoring function at the school). While as depicted the monitor data 115 is separate from the schedule data 113, in other examples, the monitor data 115 may be incorporated into the schedule data 113.

As depicted, the database 103 further stores a map 117 of the school (e.g., including, but not limited, to a map of the school building and/or grounds of the school such as floorplans, network path graphs between classrooms, or other digitally stored representations).

While a particular database structure is depicted in FIG. 1, the components of the database 103 may be stored according to any suitable structure and/or in any suitable manner including, but not limited to, storing the information in one or more databases and/or one or more memories (e.g., that may or may not include databases and/or a database structure). Hence, for example, the database 103 is understood to be stored at one or more memories and/or the database 103 may be replaced by one or more memories.

A location included in or referenced by the adversarial relationship data 111, the schedule data 113, the monitor data 115 and/or the map 117 may comprise one or more of: Global Positioning System (GPS) coordinates, indoor location coordinates, map or floorplan coordinates (e.g., of the map 117) and/or a map and/or textual descriptive school locations (e.g., “Class A”, “Gym” and the like). In some examples, map and/or school locations may be associated with locations of the map 117 and/or associated GPS coordinates and/or map coordinates.

In FIG. 1, two monitors 121-1, 121-2 are depicted, the monitors 121-1, 121-2 associated with respective communication devices 131-1, 131-2. The monitors 121-1, 121-2 and the communication devices 131-1, 131-2 will be interchangeably referred to hereafter, collectively and respectively, as the monitors 121 and the communication devices 131, and generically and respectively, as a monitor 121 and a communication device 131. While only two monitors 121 and two communication devices 131 are depicted, the system 100 may comprise any suitable number of monitors 121 and associated communication devices 131 including, but not limited to, one monitor 121 and one communication devices 131, and more than two monitors 121 and more than two communication devices 131.

The adversarial relationship data 111 may generally comprise one or more of:
Historical data indicative of a quality and/or type of adversarial incidents between the students. Such historical data may be maintained by the school in the form of electronic records of incidents and/or adversarial incidents, between students, pairs of students and/or groups of students, including, but not limited to, verbal arguments, physical fights, bullying incidents, cliques and adversarial relationships therebetween, sports teams and adversarial relationships therebetween, school clubs and adversarial relationships therebetween, gang affiliations, and the like.
Statistics indicative of a quantity of adversarial incidents between the students. Such statistics may be maintained by the school in the form of electronic records of general adversarial relationships between the students, including, but not limited to, numbers and/or times and/or locations of adversarial incidents between students. In particular, such statistics may indicate when and where adversarial incidents have occurred on school grounds in the past. The statistics may hence be used to estimate locations and times of spatiotemporal crosspaths based on locations and times of previous spatiotemporal crosspaths
Video data indicative of adversarial incidents between the students. For example, the school may include camera devices (e.g., video cameras, and the like) which monitor the school grounds, and which may capture adversarial incidents including, but not limited to, identities of students involved in an adversarial incident, and/or times and/or locations of adversarial incidents between students. In some examples the camera devices may be mobile and/or deployable to a location of the school. Data identifying the incident from the video may be automatically captured via video analytics and facial recognition programs or functions of the camera or computing device 101, and/or may be manually entered by a reviewer of the video such as by a school employee and/or security guard operating the computing device 101. Hence, the video data may comprise video captured by the camera devices.
Social media data indicative of the adversarial incidents between the students. Such social media data may be located at databases other than the database 103, though the social media data may be monitored and/or retrieved from such databases (e.g., and stored at the database 103), for example by the device 101 Indeed, the device 101 may be configured to monitor social media data and store data, indicative of adversarial relationships between the students at the database 103, as determined from monitored social media data, or may be configured to receive such indications from other monitoring devices.
Age differences between the students. For example, students of different ages (e.g., seniors vs freshman) may inherently have adversarial relationships and the age differences between the students may comprise ages and/or relative ages of the students.

The schedule data 113 may comprise one or more of:
Class schedules of the students including, but not limited to, classroom locations and times of classes, and the like, of the students having the adversarial relationships as identified in the adversarial relationship data 111, and/or the students of the school in general.
Event schedules of the students including, but not limited to, event locations and times of events such as classes, and the like, of the students having the adversarial relationships as identified in the adversarial relationship data 111, and/or the students of the school in general. Events of the event schedules may include, but are not limited to, events of school clubs (e.g., times/locations of meetings of school clubs), sporting events (e.g., times/locations of games and/or practices of school sporting teams), and the like. Indeed, the event schedules of the students may include locations such as classrooms, cafeterias, auditoriums, gyms, recreation rooms, fields, and the like, and/or any other suitable locations of the school.
Classroom locations of the school.
Shortest paths between the classroom locations which may be predetermined and/or determined from the classroom locations. In other examples, a most-likely-path as determined via video capture (or wireless device path tracking associated with the students) of actual paths taken between classrooms over time of students having same or similar source and destination classrooms, and/or of a historical path or paths typically taken by between classrooms of a particular student, may be used in place of or in addition to shortest paths.
Video data indicative of spatiotemporal locations of the students at the school. For example, as described above, the school may include camera devices which monitor the school grounds, and which may capture times and locations of students on the school grounds. For example, the video data may indicate times and locations that a student and/or group of students hang out at particular locations of the school, for example before, after and/or between classes Hence, the video data may comprise video captured by the camera devices.

The monitor data 115 may include one or more of:
Roles of the one or more monitors 121 of the school. For example, a monitor 121 may comprise one or more of a teacher, other school staff such as an administrator and/or a principal and/or a vice-principal and/or a nurse and/or administrator and/or guidance counselor, a volunteer, a hall monitor, a security guard and the like, and the roles of the monitors 121 may indicate an identity of a monitor (by assigned unique name, identifier, etc.) and their associated role (e.g., full-time role such as hall monitor or role during non-passing periods such as teacher and/or role during passing periods such as part-time monitor). Hence, the monitor data 115 may indicate whether a given monitor 121 is a teacher, school staff, an administrator, a principal, a vice-principal, a nurse, a guidance counselor, a volunteer, a hall monitor, and/or a security guard, and the like.
Schedules of the one or more monitors 121. For example, the schedules of the one or more monitors 121 may indicate locations (e.g., classroom locations and/or any other suitable location) and times of the one or more monitors 121 at the locations. For example, a given schedule of the monitor data 115 may comprise a given teacher's teaching schedule which may include times and associated locations and/or classroom locations where a teacher is scheduled to be located, and the like. The schedules of the one or more monitors 121 may hence include assigned classrooms of the one or more monitors 121; for example, a monitor 121 may be a teacher, and the monitor data 115 may specifically indicate an assigned teacher classroom location of the teacher.
Capabilities and/or skills and/or training of the one or more monitors 121. For example, the one or more monitors 121 may be trained in conflict resolution, martial arts, self-defense, and the like, and the monitor data 115 may indicate such. Capabilities and/or skills and/or training of the one or more monitors 121 may further include height and/or weight, and the like, of the monitors 121. Indeed, the monitor data 115 may include any suitable indications of the capabilities and/or skills and/or training of the one or more monitors 121, which may be used to assign monitors 121 to spatiotemporal crosspath locations to prevent students from fighting. Hence, for example, a fit physical education teacher may be assigned to a spatiotemporal crosspath location, over a less fit and/or out of shape hall monitor, where two senior students having an adversarial relationship may cross paths.
Apparatus assigned to the one or more monitors 121. For example, the monitor data 115 may indicate whether a monitor 121 has been assigned a walkie talkie (e.g., having an emergency call button, and the like), and the like, which may be used to summon assistance quickly; and/or the monitor data 115 may indicate whether a monitor 121 has been assigned other types of devices which may be used to assist with preventing a fight, and/or other adversarial incident, between students.
Availability of the one or more monitors 121. For example, a monitor 121 may be a volunteer, a hall monitor, and the like, and different monitors 121 may be available on different days and/or for different passing periods. Hence, the monitor data 115 may indicate an available pool of volunteers and/or hall monitors, and the like, on given days, and/or schedules of the volunteers and/or the hall monitors. Indeed, the availability of the one or more monitors 121 may indicate schedules and/or locations of any type of monitor 121 including, but not limited to, security guards.
Relationships between the one or more monitors 121 and the students having the adversarial relationships. For example, the monitor data 115 may indicate that a monitor 121 is a homeroom teacher and/or guidance counselor of one or more of the students. However, the monitor data 115 may further indicate whether a monitor 121 has a good or bad relationship with a student and/or whether a monitor 121 has successfully or unsuccessfully resolved a past adversarial incident and/or relationship between the students.

The adversarial relationship data 111, the schedule data 113 and the monitor data 115 may be updated periodically, for example as adversarial relationships and/or schedules of the students change, and/or as schedules and/or classroom locations of the monitors 121 change and/or are updated and/or are generated, and the like.

The map 117 of the school is understood to comprise an electronic map of the school and may include identifiers of the various locations of the schedule data 113 and/or the monitor data 115. While as depicted the map 117 is separate from the schedule data 113 and/or the monitor data 115, in other examples, the map 117 may be incorporated into the schedule data 113 and/or the monitor data 115. Regardless, spatiotemporal crosspaths at the school of the students having the adversarial relationships may be determined via the map 117, for example to determine paths between locations.

As depicted, the device 101 is in communication with communication devices 131 via respective communication links. While the communication devices 131 are depicted as mobile communication devices (e.g., such as a mobile radio and/or a cellphone and the like), one or more of the communication devices 131 may comprise a fixed position communication device, such as personal computer at a teacher's classroom, and the like.

Furthermore, the device 101 may generally communicate with the communication devices 131 to cause the monitors 121 to move to a respective assigned spatiotemporal crosspath, for example via notifications, as described below.

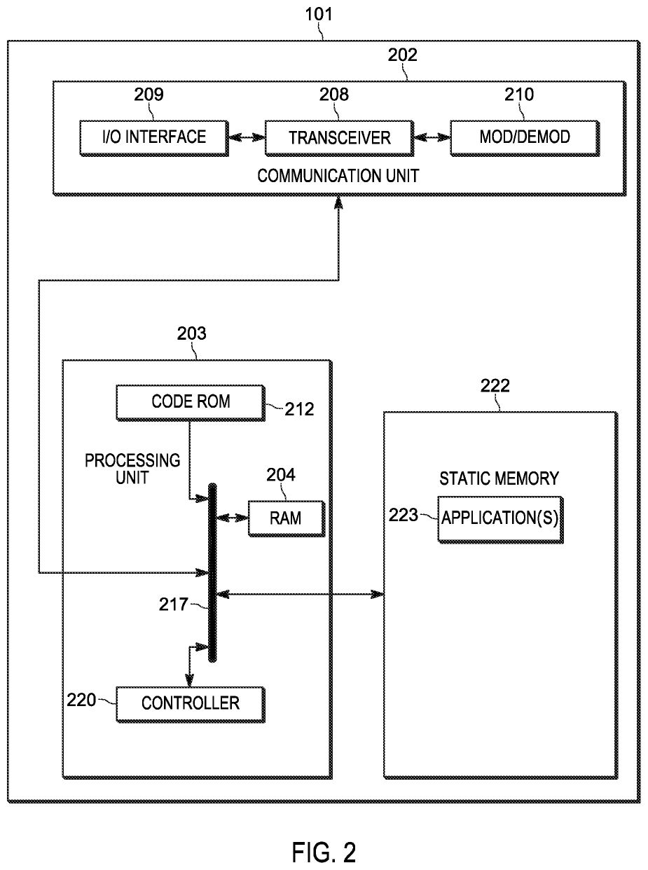

Attention is next directed to FIG. 2 which depicts a schematic block diagram of an example of the device 101. In general, the device 101 may comprise one or more servers and/or one or more cloud computing devices, and the like, configured to communicate with the communication devices 131. However, the device 101 may comprise a computing device such as a personal computer and/or a laptop computer, and the like. In some examples, the device 101 may be combined with one or more of the communication devices 131. The device 101 may be located at the school and/or located remotely from the school.

As depicted, the device 101 comprises: a communication unit 202, a processing unit 203, a Random-Access Memory (RAM) 204, one or more wireless transceivers 208, one or more wired and/or wireless input/output (I/O) interfaces 209, a combined modulator/demodulator 210, a code Read Only Memory (ROM) 212, a common data and address bus 217, a controller 220, and a static memory 222 storing at least one application 223. Hereafter, the at least one application 223 will be interchangeably referred to as the application 223. In some examples, the memory 222 may also store the database 103 and/or a portion of the database 103 and/or a portion of one or more of the adversarial relationship data 111, the schedule data 113, the monitor data 115, and the map 117.

While not depicted, the device 101 may include one or more of an input device and a display screen and the like, a microphone (e.g., to receive voice commands) such that a user may interact with the device 101.

As shown in FIG. 2, the device 101 includes the communication unit 202 communicatively coupled to the common data and address bus 217 of the processing unit 203.

The processing unit 203 may include the code Read Only Memory (ROM) 212 coupled to the common data and address bus 217 for storing data for initializing system components. The processing unit 203 may further include the controller 220 coupled, by the common data and address bus 217, to the Random-Access Memory 204 and the static memory 222.

The communication unit 202 may include one or more wired and/or wireless input/output (I/O) interfaces 209 that are configurable to communicate with the communication devices 131. For example, the communication unit 202 may include one or more transceivers 208 and/or wireless transceivers for communicating with the communication devices 131. Hence, the one or more transceivers 208 may be adapted for communication with one or more communication networks used to communicate with the communication devices 131. For example, the one or more transceivers 208 may be adapted for communication with one or more of the Internet, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) networks, a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a Bluetooth transceiver, a Wi-Fi transceiver, a WiMAX transceiver, and/or another similar type of wireless transceiver configurable to communicate via a wireless radio network.

The communication unit 202 may optionally include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The controller 220 may include ports (e.g., hardware ports) for coupling to other hardware components.

The controller 220 includes one or more logic circuits, one or more processors, one or more microprocessors, one or more ASIC (application-specific integrated circuits) and one or more FPGA (field-programmable gate arrays), and/or another electronic device. In some examples, the controller 220 and/or the device 101 is not a generic controller and/or a generic device, but a device specifically configured to implement functionality for positioning monitors in schools. For example, in some examples, the device 101 and/or the controller 220 specifically comprises a computer executable engine configured to implement functionality for positioning monitors in schools.

The static memory 222 is a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functional teachings of the device 101 as described herein are maintained, persistently, at the memory 222 and used by the controller 220 which makes appropriate utilization of volatile storage during the execution of such programming instructions.

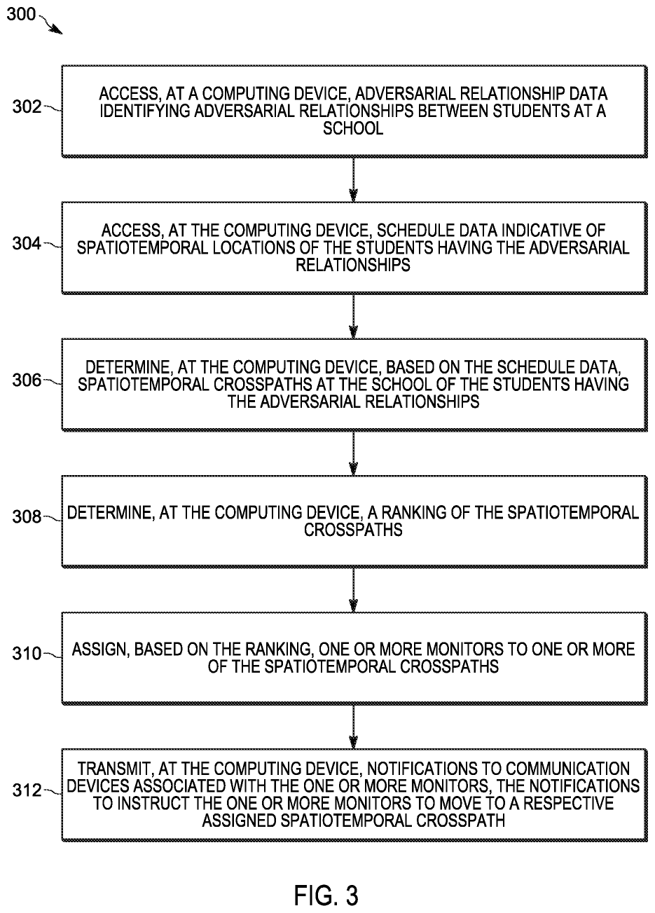

In particular, the memory 222 stores instructions corresponding to the at least one application 223 that, when executed by the controller 220, enables the controller 220 to implement functionality for positioning monitors in schools including, but not limited to, the blocks of the method set forth in FIG. 3. In illustrated examples, when the controller 220 executes the one or more applications 223, the controller 220 is enabled to: access the adversarial relationship data 111 and the schedule data 113; determine, based on the schedule data 113, spatiotemporal crosspaths at the school of the students having the adversarial relationships; determine a ranking of the spatiotemporal crosspaths; assign one or more monitors 121 to one or more of the spatiotemporal crosspaths; and transmit, via the communication unit 202, notifications to communication devices 131 associated with the one or more monitors 121, the notifications to instruct the one or more monitors 121 to move to a respective assigned spatiotemporal crosspath.

The application 223 may include numerical algorithms to one or more of: determine (e.g., based on the schedule data 113), spatiotemporal crosspaths at the school of students having the adversarial relationships; determine a ranking of the spatiotemporal crosspaths; and assign, based on the ranking, one or more monitors 121 to one or more of the spatiotemporal crosspaths.

Alternatively, the application 223 may include machine learning and/or deep-learning based algorithms and/or neural networks, and the like, which have been trained to one or more of: determine (e.g., based on the schedule data 113), spatiotemporal crosspaths at the school of students having the adversarial relationships; determine a ranking of the spatiotemporal crosspaths; and assign, based on the ranking, one or more monitors 121 to one or more of the spatiotemporal crosspaths, and/or any other suitable function. Furthermore, in these examples, the application 223 may initially be operated by the controller 220 in a training mode to train the machine learning and/or deep-learning based algorithms and/or neural networks of the application 223 to one or more of: determine (e.g., based on the schedule data 113), spatiotemporal crosspaths at the school of students having the adversarial relationships; determine a ranking of the spatiotemporal crosspaths; and assign, based on the ranking, one or more monitors 121 to one or more of the spatiotemporal crosspaths; and/or any other suitable function. Furthermore, training of the machine learning and/or deep-learning based algorithms and/or neural networks, and the like may continue as adversarial relationship data 111, the schedule data 113 and/or the monitor data 115 is updated.

The one or more machine learning algorithms and/or deep learning algorithms and/or neural networks of the application 223 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms, reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some public-safety environments; for example, while a school may not be a public safety environment, data generated by the one or more machine learning algorithms and/or deep learning algorithms and/or neural networks may later be used to file charges if an adversarial incident occurs. However, any suitable machine learning algorithm and/or deep learning algorithm and/or neural network is within the scope of present examples.

While details of the communication devices 131 are not depicted, the communication devices 131 may have components similar to the device 101 adapted, however, for the functionality of the communication devices 131. For example, the communication devices 131 may include respective display screens, speakers, microphones, location determining devices (e.g., GPS devices), and the like.

Attention is now directed to FIG. 3 which depicts a flowchart representative of a method 300 for positioning monitors in schools. The operations of the method 300 of FIG. 3 correspond to machine readable instructions that are executed by the device 101, and specifically the controller 220 of the device 101. In the illustrated example, the instructions represented by the blocks of FIG. 3 are stored at the memory 222 for example, as the application 223. The method 300 of FIG. 3 is one way in which the controller 220 and/or the device 101 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

At a block 302, the controller 220 and/or the device 101 accesses the adversarial relationship data 111.

At a block 304, the controller 220 and/or the device 101 accesses the schedule data 113. For example, at the block 302 and the block 304, the controller 220 and/or the device 101 may access the database 103 to retrieve the adversarial relationship data 111 and the schedule data 113. The block 302 and the block 304 may further comprise accessing the monitor data 115 and/or the map 117.

At a block 306, the controller 220 and/or the device 101 determines, based on the schedule data 113, spatiotemporal crosspaths at the school of the students having the adversarial relationships.

As indicated above, a given spatiotemporal crosspath generally identifies a respective time and a respective location at the school where two or more of the students having an adversarial relationship are predicted and/or estimated to cross paths. A location of the spatiotemporal crosspath may comprise any suitable location data including, but not limited to, GPS coordinates, map coordinates (e.g., of the map 117) and or a map and/or school location (e.g., “Hallway Between Class I and Class K” and the like. A crosspath may be a specific point location (e.g., specific longitude and latitude), a specific hallway or intersection of hallways, or a defined sub-portion of an entire path from a source classroom to a destination classroom over which the identified adversarial students would likely overlap.

A specific spatiotemporal crosspath may be determined by: estimating respective paths, from the schedule data 113, for two or more students having adversarial relationships, as identified from the adversarial relationship data 111 from respective first locations to respective second locations, and times therefor; and estimating a respective location and a respective time, that the respective paths of the two or more students, having adversarial relationships, intersect (and/or cross and/or overlap).

For example, respective paths of the students may be determined and/or estimated from the schedule data 113. The schedule data 113 may indicate respective source/starting locations (e.g., a first location, such as a first classroom location) and destination/ending locations (e.g., a second location, such as a second classroom location) of students which may be used to determine an estimated path. The schedule data 113 may further indicate respective starting times (e.g., a time a first class at the first classroom location ends) and ending times (e.g., a time a second class, following the first class, at the second classroom location begins) of the estimated path. An estimated path may comprise a shortest path, and the like, between a respective starting and ending location, though any type of estimated path is within the scope of the present specification. A crosspath location may comprise an intersection between two estimated paths, and an estimated spatiotemporal crosspath may comprise the crosspath location and a time that the students having the adversarial relationship may be at the crosspath location.

However, an estimated path may be modified or may instead be based on known and/or determined historical behavior of a student. For example, the schedule data 113 may indicate that a given student visits their locker and/or a washroom between classes, and the estimated path may be determined and/or modified accordingly, as well as the respective starting and ending times of the estimated path.

Furthermore, a buffer time, and the like, may be used to estimate and/or modify, respective starting and ending times of an estimated path for example to account for a student being let out early from a class, and/or arriving late to a class and/or moving slowly and/or quickly. In some examples, the buffer time may be a predetermined buffer time, such as 5 minutes. In other examples, the buffer time may further be determined based on video data of the students as they move between classes and/or locations, and/or the schedule data 113 may indicate historical instances of students being let out early from a class, and/or arriving late to a class and/or moving slowly and/or quickly. Regardless, a spatiotemporal crosspath location may indicate a time period over which two or more students are estimated to cross paths at a given location.

At a block 308, the controller 220 and/or the device 101 determines a ranking of the spatiotemporal crosspaths. For example, the controller 220 and/or the device 101 may determine the ranking of the spatiotemporal crosspaths based on one or more of: the adversarial relationship data 111; and a number of the students having the adversarial relationships crossing paths at a given spatiotemporal crosspath.

For example, the ranking may indicate a severity level of a possible adversarial incident occurring at a given spatiotemporal crosspath, for example based on severity levels of past adversarial incidents indicated by the adversarial relationship data 111. For example, when a first spatiotemporal crosspath is for two students who previously engaged in a physical fight, and a second spatiotemporal crosspath is for two students who previously engaged in an argument, but without physically fighting, the first spatiotemporal crosspath may be ranked higher than the second spatiotemporal crosspath. Put another way, a severity level of a physical fight may be higher than a severity level of an argument. Put yet another way, severity levels may be assigned (e.g., manually and/or electronically) to adversarial relationships indicated by the adversarial relationship data 111, using any suitable criteria, and given spatiotemporal crosspaths may be ranked accordingly. Similarly, severity levels may be assigned to the spatiotemporal crosspaths, for example based on the severity levels of the associated adversarial relationships. Such severity levels of spatiotemporal crosspaths may be assigned based on any suitable criteria and using any suitable scale (e.g., 1 to 10, and the like, with higher severity levels indicating a higher severity (e.g., more violent) of a possible adversarial incident occurring, and lower severity levels indicating a lower severity (e.g., less violent) of a possible adversarial incident occurring). However, rankings of spatiotemporal crosspaths based on adversarial relationship data 111 may occur using machine learning algorithms, and the like.

In further examples, a number of the students having the adversarial relationships crossing paths at a given spatiotemporal crosspath may additionally or alternatively be used to rank the spatiotemporal crosspaths. For example, a first spatiotemporal crosspath may have more students having adversarial relationships crossing paths than a second spatiotemporal crosspath; the first spatiotemporal crosspath may hence be ranked higher than the second spatiotemporal crosspath.

However, rankings of spatiotemporal crosspaths may occur in any suitable manner, for example using machine learning algorithms, and the like.

At a block 310, the controller 220 and/or the device 101 assigns one or more monitors 121 to one or more of the spatiotemporal crosspaths. For example, the assigning may comprise assigning the one or monitors 121 to a higher ranked spatiotemporal crosspath before assigning the one or monitors 121 to a lower ranked spatiotemporal crosspath. Hence, higher ranked spatiotemporal crosspaths are given preference over lower ranked spatiotemporal crosspaths. Indeed, when there are fewer monitors 121 available than there are spatiotemporal crosspaths, the higher ranked spatiotemporal crosspaths may be monitored, but the lower ranked spatiotemporal crosspaths may not be monitored.

Furthermore, more than one monitor 121 may be assigned to a spatiotemporal crosspath, for example as based on the ranking. For example, assigning more than one monitor 121 to a spatiotemporal crosspath may be threshold based. In such examples, when a spatiotemporal crosspath is associated with a severity level above a threshold severity level (e.g., “5” on a scale of 1 to 10), two or more monitors 121 may be assigned to the spatiotemporal crosspath (e.g., when available). Similarly, when a spatiotemporal crosspath is associated with a number of students having an adversarial relationship above a threshold number of students (e.g., three students), two or more monitors 121 may be assigned to the spatiotemporal crosspath (e.g., when available). However, any suitable threshold severity level and/or threshold number of students is within the scope of the present specification.

The controller 220 and/or the device 101 may assign one or more monitors 121 to one or more of the spatiotemporal crosspaths using any suitable criteria, for example as indicated by the monitor data 115 as described above. In particular, the assigning may be based on one or more of:
A respective time and a respective location of a given monitor 121 relative to a spatiotemporal crosspath. For example, the monitor data 115 may indicate a closest monitor 121 to a spatiotemporal crosspath (e.g., both spatially and in time) and the closest monitor 121 may be assigned to the spatiotemporal crosspath. In some examples, the closest monitor 121 may be based on a stored non-passing period location of the monitor 121, such as classroom, administrative office (for admin or nurse), security office (for security officer), or other location. In further examples, a respective location of a monitor 121 may include, but is not limited to, an assigned classrooms of the one or more monitors 121; the monitor data 115 may hence indicate that a monitor 121 is assigned to a classroom closest to a spatiotemporal crosspath (e.g., at a stored non-passing period of the monitor 121) and the monitor 121 may be assigned to the spatiotemporal crosspath.
Whether the given monitor 121 is a teacher, school staff, an administrator, a principal, a vice-principal, a nurse, a guidance counselor, a volunteer, a hall monitor, and/or a security guard, and the like. For example, higher relatively skilled (e.g., in security) security guards may be assigned to spatiotemporal crosspaths having higher severity levels than lower relatively skilled (e.g., in security) teachers and/or volunteers, hall monitor, etc.; similarly, teachers guards may be assigned to spatiotemporal crosspaths having higher severity levels than volunteers, hall monitor, etc. Indeed, such assignment may be threshold based, with security guards assigned (and/or first assigned) to spatiotemporal crosspaths having a severity level above a first threshold, and teachers assigned (and/or first assigned) to spatiotemporal crosspaths having a severity level above a second threshold lower than the first threshold.
Capabilities and/or skills and/or training of the one or more monitors 121. For example, different capabilities and/or skills and/or training may be associated with different severity levels of crosspaths, such that that a monitor 121 having training in martial arts and/or self-defense may be assigned to spatiotemporal crosspaths above an associated severity level. However, a monitor 121 having capabilities and/or skills and/or training may be assigned to a spatiotemporal crosspath depending on a type of possible adversarial incident that may occur at the spatiotemporal crosspath. For example, when a possible adversarial incident at a spatiotemporal crosspath comprises an argument, but not a physical fight, a monitor 121 with conflict resolution training may be assigned to the spatiotemporal crosspath. Similarly, when a possible adversarial incident at a spatiotemporal crosspath comprises a physical fight, a monitor 121 with martial arts and/or self-defense training may be assigned to the spatiotemporal crosspath.
Apparatus assigned to the one or more monitors 121. For example, monitors 121 having given apparatus (such as walkie talkies and/or devices which may be used to assist with preventing a fight, and/or other adversarial incident, between students) may be assigned to higher ranked spatiotemporal crosspaths, similar to as described above.
Schedules of the one or more monitors 121. For example, the monitor data 115 may indicate that a schedule of a monitor 121 places the monitor closest (e.g., with regards to both location and time) to a spatiotemporal crosspath and the monitor 121 may be assigned to the spatiotemporal crosspath.
Availability (based on day, passing period, etc.) of the one or more monitors 121. For example, the monitor data 115 may indicate that a monitor 121 is available to move to a spatiotemporal crosspath and such an available monitor 121 may be assigned to the spatiotemporal crosspath.
Relationships between the one or more monitors 121 and the students having the adversarial relationships. For example, the monitor data 115 may indicate that a monitor 121 has a good relationship with a student at a spatiotemporal crosspath and/or that a monitor 121 has had success in resolving previous adversarial incidents and/or relationships between students. Such monitors 121 may be assigned to a spatiotemporal crosspath before monitors 121 with bad relationships and/or poor success in resolving previous adversarial incidents and/or relationships between students.

In specific examples, the one or more monitors 121 may comprise teachers, and the assigning, based on the ranking, the one or more monitors 121 to one or more of the spatiotemporal crosspaths, may be based on a distance between respective teacher classroom locations and spatiotemporal crosspath locations. For example, a teacher at a classroom location closest to spatiotemporal crosspath location may be assigned to the associated spatiotemporal crosspath.

At a block 312, the controller 220 and/or the device 101 transmits, via the communication unit 202, notifications to communication devices 131 associated with the one or more monitors 121, the notifications to instruct the one or more monitors 121 to move to a respective assigned spatiotemporal crosspath.

For example, the notification may comprise a location and time of a spatiotemporal crosspath to which a monitor 121 is assigned. The notification may be provided at a display screen and/or a speaker of a communication device 131. Hence, the monitor 121 may move to the location of an assigned spatiotemporal crosspath for the time and/or time period of the assigned spatiotemporal crosspath.

Alternatively, a notification may comprise a name and/or an image one or more of the students having the adversarial relationships, which may be provided at a display screen of a communication device 131 (and/or the name may be provided at a speaker of the communication device 131), such that a monitor 121 may identify the one or more of the students having the adversarial relationships and proactively position themselves to prevent the students from interacting with each other.

In some alternative examples, the method 300 may further comprise the controller 220 and/or the device 101 transmitting an instruction, to a respective communication device 131 of a respective monitor 121, at a starting location of a first student having an adversarial relationship with a second student, the instruction to instruct the respective monitor 121 to hold back the first student at the starting location to prevent the first student from crossing paths with the second student on route to an ending location. Hence, for example, an instruction may be transmitted to a communication device 131 of a teacher at a classroom of the first student, for example prior to an end of a class, to instruct the teacher to hold back the first student for a given period of time after the end of the class, to reduce a possibility of the first student crossing paths with the second student when the first student moves to a next class (e.g., an ending location).

In some of these examples, the method 300 may further comprise the controller 220 and/or the device 101 transmitting another instruction, to another respective communication device 131 of another respective monitor 121 at the ending location of the first student to instruct the another respective monitor 121 that the first student may be late to arrive at the ending location. For example, the another respective monitor 121 may be a teacher of the next class of the first student being held back, and the instruction transmitted to their communication device 131 may be to inform them that there is a reason the first student may be late (e.g., and/or so the teacher of the next class does not punish the first student for being late).

In yet further examples, the method 300 may comprise the controller 220 and/or the device 101 controlling a camera device to monitor a given spatiotemporal crosspath. For example the map 117, and the like, may indicate locations of camera devices at the school and, when the map 117 indicates that a camera device is positioned to acquire images and/or video of a given spatiotemporal crosspath, the controller 220 and/or the device 101 may control the camera device to acquire images of the crosspath location at the time and/or time period associated with the given spatiotemporal crosspath and store the captured images and/or video for future access when an incident occurs and/or transmit the images and/or video to a configured monitoring station, such as the computing device 101, for simultaneous monitoring of a plurality of crosspaths. In some examples, assigning a monitor to a crosspath may include assigning a capable mechanical, optical, and/or digital pan, tilt, and/or zoom (e.g., PTZ) camera to a crosspath, and transmitting a notification in such an example may include transmitting an instruction to PTZ to the identified crosspath record and transmit video of the identified crosspath to the monitoring station. In some examples, controlling a camera device to monitor a given spatiotemporal crosspath may include deploying a mobile camera device to the given spatiotemporal crosspath (e.g., which may include assigning a monitor 121 to manually carry a mobile camera device to the given spatiotemporal crosspath and/or controlling the mobile camera device automatically move to the given spatiotemporal crosspath).

In yet further examples, the method 300 may include the controller 220 and/or the device 101 changing a class schedule of one or more of the students based on the rankings. For example, the controller 220 and/or the device 101 may determine that given students having adversarial relationships may regularly cross paths at given locations and times, and that the associated spatiotemporal crosspaths are relatively highly ranked. Hence, to prevent the students from regularly crossing paths at given locations and times, the class schedule (e.g., as stored in the schedule data 113) of one or more of the students may be changed (and/or may be suggested and/or prompted to be changed) to reduce the likelihood of their crossing paths, for example to assign the students to different classes in different locations. Indeed, at a beginning of a term and/or a school year, the controller 220 and/or the device 101 implement block 302, 304, block 306 and block 308 of the method 300 to determine one or more lists of spatiotemporal crosspaths of students having adversarial relationships, and adjust class schedules (e.g., as stored in the schedule data 113) iteratively, and the like to reduce severity and/or number of occurrences of spatiotemporal crosspaths for the term and/or the school year. Similarly, the controller 220 and/or the device 101 implement block 302, 304, block 306 and block 308 of the method 300 periodically and/or as the adversarial relationship data 111 changes and/or is updated, to determine one or more lists of spatiotemporal crosspaths of students having adversarial relationships, and adjust class schedules (e.g., as stored in the schedule data 113) iteratively, and the like to reduce severity and/or number of occurrences of spatiotemporal crosspaths.

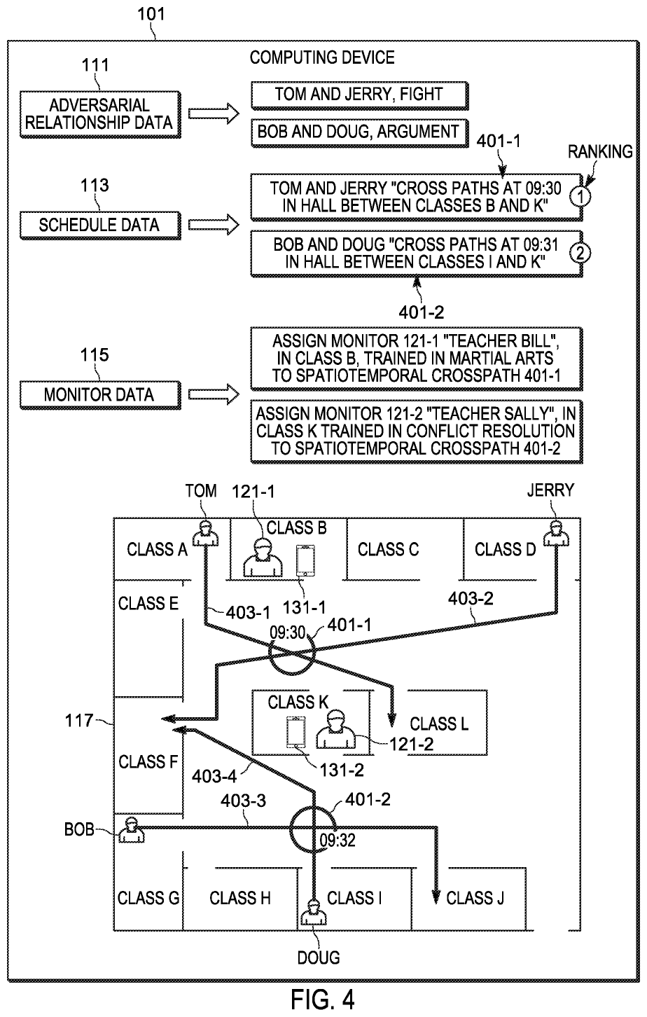

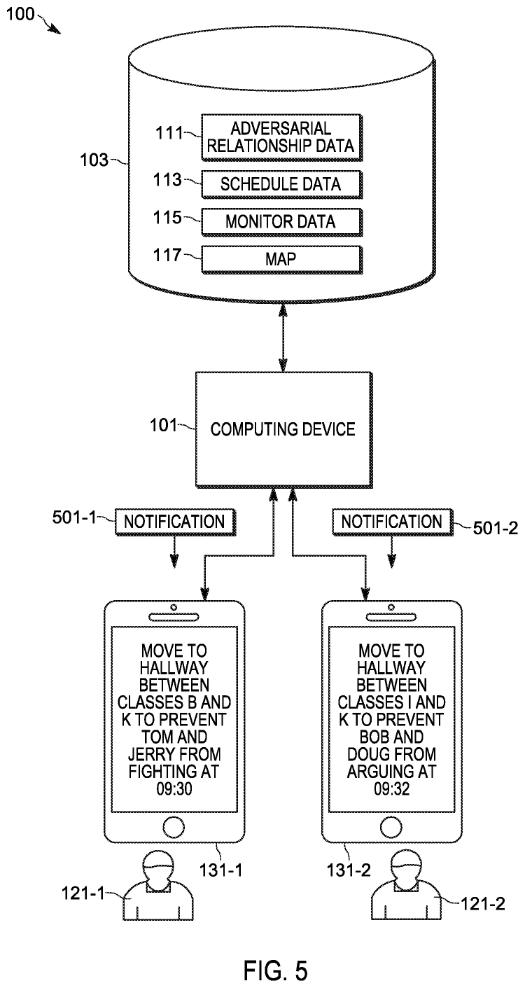

An example of the method 300 is next described with respect to FIG. 4 and FIG. 5. While FIG. 4 depicts the device 101 without other components of the system 100, the device 101 is nonetheless understood to be in communication with the database 103 and the communication devices 131. FIG. 5 is similar to FIG. 1 with like components having like numbers.

In particular, FIG. 4 depicts the device 101 accessing (e.g., at the block 302 and the block 304) the adversarial relationship data 111 and the schedule data 113; for example, as depicted, the device 101 has retrieved the adversarial relationship data 111 and the schedule data 113 from the database 103.

In the depicted example of FIG. 4, the device 101 identifies (e.g., at the block 306), using the adversarial relationship data 111, students “Tom” and “Jerry” who have an adversarial relationship due to a past “Fight” (e.g., an adversarial incident) between them. Similarly, the device 101 identifies, using the adversarial relationship data 111, students “Bob” and “Doug” who have an adversarial relationship due to a past “Argument” (e.g., an adversarial incident) between them.

In the depicted example of FIG. 4, the device 101 determines (e.g., at the block 306), using the schedule data 113, that the students “Tom” and “Jerry” are estimated to “Cross Paths At 09:30 In Hall Between Classes B And K”, and that the students “Bob” and “Doug” are estimated to “Cross Paths At 09:32 In Hall Between Classes I And K”. Indeed, the data “Cross Paths At 09:30 In Hall Between Classes B And K” and the data “Cross Paths At 09:32 In Hall Between Classes I And K” may each be examples of, and/or represent, spatiotemporal crosspaths 401-1, 401-2 (interchangeably referred to hereafter, collectively, as the spatiotemporal crosspaths 401 and, generically, as a spatiotemporal crosspath 401). However, a spatiotemporal crosspath 401 may be provided in any suitable format, including, but not limited to a location and a time (and/or time period and entire path sub-portion).

FIG. 4 further depicts the device 101 determining the spatiotemporal crosspaths 401-1, 401-2 using the map 117. In particular, FIG. 4 depicts the device 101 determining, using the map 117, that the student “Tom” may use a path 403-1 (e.g., a shortest path, and the like) to move from “Class A” to “Class L” at a given time (e.g., as determined from the schedule data 113), and the student “Jerry” may use a path 403-2 (e.g., a shortest path, and the like) to move from “Class D” to “Class F” at a respective given time (e.g., as determined from the schedule data 113). The device 101 may further determine that the paths 403-1, 403-2 intersect, in a hall of the school, between Class B and Class K, at 09:30. Hence, the device 101 determines the spatiotemporal crosspath 401-1 based on the intersection of the paths 403-1, 403-2 at the time 09:30.

Similarly, FIG. 4 depicts the device 101 determining, using the map 117, that the student “Bob” may use a path 403-3 (e.g., a shortest path, and the like) to move from “Class G” to “Class J” at a given time (e.g., as determined from the schedule data 113), and the student “Doug” may use a path 403-4 (e.g., a shortest path, and the like) to move from “Class I” to “Class F” at a respective given time (e.g., as determined from the schedule data 113). The device 101 may further determined that the paths 403-3, 403-4 intersect, in a hall of the school, between Class I And Class K, at 09:32. Hence, the device 101 determines the spatiotemporal crosspath 401-2 based on the intersection of the paths 403-3, 403-4 at the time 09:32.

As depicted, the device 101 further ranks (e.g., at the block 308 of the method 300) the spatiotemporal crosspaths 401. For example, the spatiotemporal crosspath 401-1 is ranked “1”, and the spatiotemporal crosspath 401-2 is ranked “2”. For example, the spatiotemporal crosspath 401-1 may be ranked higher than the spatiotemporal crosspath 401-2, as the students associated with the spatiotemporal crosspath 401-1 were involved in a fight (e.g., a higher severity adversarial incident relative to an argument) while the students associated with the spatiotemporal crosspath 401-2 were involved in an argument (e.g., a lower severity adversarial incident relative to a fight). Other types of relative and/or absolute rankings could be used as well and/or instead.

As depicted, the device 101 further assigns (e.g., at the block 310 of the method 300), based on the rankings, monitors 121 to the spatiotemporal crosspaths 401. In the depicted example, there are two monitors 121 available to be assigned to the two spatiotemporal crosspaths 401; however, when only one monitor 121 is available to be assigned, the one monitor 121 is assigned to the higher ranked spatiotemporal crosspath 401-1.

Locations of the monitors 121 are also depicted on the map 117. Indeed, from the map 117 it is understood that the monitor 121-2 could be assigned to either spatiotemporal crosspath 401 based only on distance from a classroom location of the monitor 121-2 to the spatiotemporal crosspaths 401. For example, the monitor 121-2 in “Class K” is about equidistant from each of the spatiotemporal crosspaths 401. However the capabilities and/or training and/or skills of the monitors 121 may also be used to assign the monitors 121 to the spatiotemporal crosspaths 401.

For example, as depicted, the device 101 uses the monitor data 115 to assign the monitor 121-1 to the higher ranked spatiotemporal crosspath 401-1 as the monitor 121-1 (e.g., “Teacher Bill”) may be closest to the spatiotemporal crosspath 401-1 (e.g., in “Class B”) and has martial arts training. Hence, the monitor 121-1 may be capable of getting to the spatiotemporal crosspath 401-1 fastest and/or preventing (and/or breaking up) a fight between the students “Tom” and “Jerry”. Similarly, as depicted, the device 101 uses the monitor data 115 to assign the monitor 121-2 to the lower ranked spatiotemporal crosspath 401-2 as the monitor 121-2 (e.g., “Teacher Sally”) is closest to the spatiotemporal crosspath 401-2 (e.g., in “Class K”) has conflict resolution training. Hence, the monitor 121-2 may be capable of getting to the spatiotemporal crosspath 401-2 fastest and/or preventing (and/or breaking up) an argument between the students “Bob” and “Doug”.

Attention is next directed to FIG. 5 which depicts the device 101 transmitting (e.g., at the block 312) respective notifications 501-1, 501-2 to the communication devices 131-1, 131-2 associated with the monitors 121-1, 121-2. As depicted, the notifications 501-1, 501-2 include text, as rendered at display screens of the communication devices 131-1, 131-2, to instruct the monitors 121-1, 121-1 to move to a respective assigned spatiotemporal crosspath 401. For example, as depicted, the communication device 131-1 of the monitor 121-1 renders text of the notification 501-1 to instruct the monitor 121-1 to “Move To Hallway Between Classes B and K To Prevent Tom And Jerry From Fighting at 09:30” (e.g., the spatiotemporal crosspath 401-1); similarly, the communication device 131-2 of the monitor 121-2 renders text of the notification 501-2 to instruct the monitor 121-2 to “Move To Hallway Between Classes I and K To Prevent Bob And Doug From Arguing at 09:32” (e.g., the spatiotemporal crosspath 401-2). However, any suitable notifications are within the scope of the present specification.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method comprising:
accessing, at a computing device, adversarial relationship data identifying adversarial relationships between students at a school;
accessing, at the computing device, schedule data indicative of spatiotemporal locations of the students having the adversarial relationships;
determining, at the computing device, based on the schedule data, spatiotemporal crosspaths at the school of the students having the adversarial relationships;
determining, at the computing device, a ranking of the spatiotemporal crosspaths;
assigning, based on the ranking, one or more monitors to one or more of the spatiotemporal crosspaths; and
transmitting, at the computing device, notifications to communication devices associated with the one or more monitors, the notifications to instruct the one or more monitors to move to a respective assigned spatiotemporal crosspath.

2. The method of claim 1, wherein a given spatiotemporal crosspath identifies a respective time and a respective location at the school where two or more of the students having an adversarial relationship are estimated to cross paths.

3. The method of claim 1, wherein the adversarial relationship data comprises one or more of:
historical data indicative of adversarial incidents between the students;
statistics indicative of the adversarial incidents between the students;
video data indicative of the adversarial incidents between the students;
social media data indicative of the adversarial incidents between the students; and
age differences between the students.

4. The method of claim 1, wherein the schedule data comprises one or more of:
class schedules of the students;
event schedules of the students;
classroom locations;
shortest paths between the classroom locations; and
video data indicative of spatiotemporal locations of the students at the school.

5. The method of claim 1, wherein determining the ranking of the spatiotemporal crosspaths is based on one or more of:
the adversarial relationship data; and
a number of the students having the adversarial relationships crossing paths at a given spatiotemporal crosspath.

6. The method of claim 1, wherein the assigning the one or more monitors to one or more of the spatiotemporal crosspaths comprises:
assigning the one or monitors to a higher ranked spatiotemporal crosspath before assigning the one or monitors to a lower ranked spatiotemporal crosspath.

7. The method of claim 1, wherein the assigning the one or more monitors to one or more of the spatiotemporal crosspaths is based on one or more of:
a respective time and a respective location of a given monitor relative to a spatiotemporal crosspath;
whether the given monitor is a teacher, an administrator, a principal, a vice-principal, a nurse, a guidance counselor, a volunteer, a hall monitor, or a security guard;
capabilities of the one or more monitors;
skills of the one or more monitors;
training of the one or more monitors;
apparatus assigned to the one or more monitors;
assigned classrooms of the one or more monitors;
schedules of the one or more monitors;
availability of the one or more monitors; and
relationships between the one or more monitors and the students having the adversarial relationships.

8. The method of claim 1, wherein the one or more monitors comprise teachers, and wherein the assigning, based on the ranking, the one or more monitors to one or more of the spatiotemporal crosspaths, is based on a distance between respective teacher classroom locations and spatiotemporal crosspath locations.

9. The method of claim 1, further comprising:
transmitting, at the computing device, an instruction, to a respective communication device of a respective monitor at a starting location of a first student having an adversarial relationship with a second student, the instruction to instruct the respective monitor to hold back the first student at the starting location to prevent the first student from crossing paths with the second student on route to an ending location.

10. The method of claim 1, further comprising:
controlling, at the computing device, a camera device to monitor a given spatiotemporal crosspath.

11. The method of claim 1, wherein the notifications comprise images of the students having the adversarial relationships.

12. The method of claim 1, further comprising:
changing a class schedule of one or more of the students based on the rankings.

13. A device comprising:
a communication unit;
a controller in communication with the communication unit and having access to one or more memories storing: adversarial relationship data identifying adversarial relationships between students at a school; and schedule data indicative of spatiotemporal locations of the students having the adversarial relationships, the controller configured to:
access the adversarial relationship data and the schedule data;
determine, based on the schedule data, spatiotemporal crosspaths at the school of the students having the adversarial relationships;
determine a ranking of the spatiotemporal crosspaths;
assign one or more monitors to one or more of the spatiotemporal crosspaths; and
transmit, via the communication unit, notifications to communication devices associated with the one or more monitors, the notifications to instruct the one or more monitors to move to a respective assigned spatiotemporal crosspath.

14. The device of claim 13, wherein a given spatiotemporal crosspath identifies a respective time and a respective location at the school where two or more of the students having an adversarial relationship are estimated to cross paths.

15. The device of claim 13, wherein the adversarial relationship data comprises one or more of:
historical data indicative of adversarial incidents between the students;
statistics indicative of the adversarial incidents between the students;
video data indicative of the adversarial incidents between the students;
social media data indicative of the adversarial incidents between the students; and
age differences between the students.

16. The device of claim 13, wherein the schedule data comprises one or more of:
class schedules of the students;
event schedules of the students;
classroom locations;
shortest paths between the classroom locations; and
video data indicative of spatiotemporal locations of the students at the school.

17. The device of claim 13, wherein the controller is further configured to determine the ranking of the spatiotemporal crosspaths based on one or more of:
the adversarial relationship data; and
a number of the students having the adversarial relationships crossing paths at a given spatiotemporal crosspath.

18. The device of claim 13, wherein the controller is further configured to assign the one or more monitors to one or more of the spatiotemporal crosspaths by:
assigning the one or monitors to a higher ranked spatiotemporal crosspath before assigning the one or monitors to a lower ranked spatiotemporal crosspath.

19. The device of claim 13, wherein the controller is further configured to assign the one or more monitors to one or more of the spatiotemporal crosspaths based on one or more of:
a respective time and a respective location of a given monitor relative to a spatiotemporal crosspath;
whether the given monitor is a teacher, an administrator, a principal, a vice-principal, a nurse, a guidance counselor, a volunteer, a hall monitor, or a security guard;
capabilities of the one or more monitors;
skills of the one or more monitors;
training of the one or more monitors;
apparatus assigned to the one or more monitors;
assigned classrooms of the one or more monitors;
schedules of the one or more monitors;
availability of the one or more monitors; and
relationships between the one or more monitors and the students having the adversarial relationships.

20. The device of claim 13, wherein the one or more monitors comprise teachers, and wherein the controller is further configured to assign, based on the ranking, the one or more monitors to one or more of the spatiotemporal crosspaths, based on a distance between respective teacher classroom locations and spatiotemporal crosspath locations.
